(19) United States
(12) Patent Application Publication
(10) Pub. No.: US 2014/0106749 A1
(43) Pub. Date: Apr. 17, 2014

(54) METHOD, APPARATUS, COMPUTER PROGRAM PRODUCT, COMPUTER READABLE MEDIUM AND SYSTEM FOR CELL RESELECTION

(71) Applicant: NOKIA SIEMENS NETWORKS OY, Espoo (FI)

(72) Inventors: Bernhard WEGMANN, Holzkirchen (DE); Ingo VIERING, Munich (DE); Cinzia SARTORI, Munich (DE); Simone REDANA, Munich (DE)

(73) Assignee: NOKIA SIEMENS NETWORKS OY, Espoo (FI)

(21) Appl. No.: 13/650,725

(22) Filed: Oct. 12, 2012

(51) Int. Cl. H04W 36/00

(52) U.S. Cl. 455/436

(57) ABSTRACT

Certain embodiments relate to a multi-layer mobile communication network using traffic steering mechanisms. The multiple layers may comprise one or several frequency layers of third generation partnership project (3GPP) long term evolution (LTE), for example, 800 MHz and 2.6 GHz, and/or one or several frequency layers of 3GPP universal terrestrial radio access network (UTRAN) (3G) and the like. For example, operators may want to steer certain UE groups to different layers. A method may comprise selecting a group definition for a set of cell reselection priorities. The method may also comprise sending the group definition for the set of cell reselection priorities to a user equipment. The group definition for the set of cell reselection priorities may be configured to permit the user equipment to autonomously reselect while in idle mode.

### BACKGROUND

1. Field

Certain embodiments relate to a multi-layer mobile communication network using traffic steering mechanisms. The multiple layers may comprise one or several frequency layers of third generation partnership project (3GPP) long term evolution (LTE), for example, 800 MHz and 2.6 GHz, and/or one or several frequency layers of 3GPP universal terrestrial radio access network (UTRAN) (3G) and the like. For example, operators may want to steer certain UE groups to different layers.

2. Description of the Related Art

The current specification allows two different kinds of absolute priorities for selecting a cell when being in idle mode: globally broadcasted absolute priorities, which are broadcasted in system information block (SIB), and dedicated absolute priorities, which are sent to a specific user during radio resource control (RRC) connection release. If dedicated absolute priorities are configured, the terminal will conventionally ignore the broadcasted priorities.

Conventionally, the global priorities will be used by all users camping on this cell, except those where dedicated priorities are configured. Thus, conventionally all users use the same priority list.

3G has specified a feature called “hierarchical cell structure” (HCS) where a velocity dependent behavior of the user equipments (UEs) in idle mode may be forced by extending the definition of absolute priorities. However, this feature is not available in LTE, and it is not flexible at all. Moreover, velocity is only one criterion.

Dedicated priorities may be configured individually for every user, when the terminal is not in idle mode. Nevertheless, dedicated priorities conventionally are valid during the whole idle mode, or for a limited time, after which the user equipment will fall back to the absolute priorities. So if any property of the terminal may change during the idle mode (for example when the terminal changes its velocity), the dedicated priorities conventionally remain as configured during connection release.

A related issue is that a terminal conventionally has to permanently conduct inter-frequency measurements when the layer with the highest priority is not available. This may drain the battery of the terminal. Additionally, conventionally a terminal is out of network control while being in idle mode, for purposes such as saving energy and network resources.

### SUMMARY

According to a first embodiment, a method may comprise selecting a group definition for a set of cell reselection priorities. The method may also comprise sending the group definition for the set of cell reselection priorities to a network element. The group definition for the set of cell reselection priorities may be configured to permit the network element to autonomously perform a reselection by applying the set of cell reselection priorities while the network element is in idle mode.

In a variation, the group definition may comprise at least one of the following criteria: a service type supported by the network element; location of the network element; cell size of a selectable cell; signal strength of a selectable cell; received signal quality of a selectable cell; cell identity of a selectable cell; tracking area where a selectable cell belongs to; geographic position of the network element; velocity of the network element; amount of data expected to be send by the network element; network element category; network element type; or network operator of the network element.

In a variation, the set of cell reselection priorities may comprise global absolute reselection priorities or dedicated absolute reselection priorities.

In a variation, the set of cell reselection priorities may be sent together with the group definition.

In a variation, the sending may comprise broadcasting or multicasting.

In a variation, at least one condition may be selected and sent indicating that the group definition shall be not applied when the condition is met.

In a variation, the sending may be performed by a base station, relay node, or an access point.

In a variation, at least two group definitions may be selected and sent.

In a variation, the network element may be a user equipment or a relay node.

In a variation, the selecting may comprise selecting from a predefined set of group definitions.

In a variation, the method may also comprise sending the group definition for the set of cell reselection priorities together with a global absolute reselection priority or a dedicated absolute reselection priority.

In a variation, the sending of the group definition for the set of cell reselection priorities to the network element may comprise sending a plurality of sets of global absolute reselection priorities for different groups of network elements or sending a plurality of sets of dedicated absolute reselection priorities for different groups of network elements.

According to a second embodiment, a method may comprise receiving a group definition for a set of cell reselection priorities at a network element. The method may also comprise initiating autonomous reselection of a cell during an idle mode of the network element by applying the set of cell reselection priorities when the network element falls within the group definition.

The second embodiment may include any of the variations of the first embodiment.

In a variation, the set of cell reselection priorities may be received together with the group definition.

In a variation, at least two group definitions may be received.

In a variation, the method may also comprise periodically checking a group status of the network element during the idle mode to initiate the autonomous reselection based on the group status.

In a variation, the group definition for the set of cell reselection may comprise an indication or instruction to remove a dedicated priority and fall back to an absolute priority when a predetermined condition occurs.

In a variation, the group definition for the set of cell reselection priorities may define priorities corresponding to at least of one different services, different locations, different terminal categories, different terminal properties, different operators, different data amounts, or different mobility states.

In a variation, the different locations may comprise subareas defined by at least one of signal strength, signal quality conditions, cell identity, tracking area, or geographic position.

The first embodiment may also comprise any of the variants of the second embodiment.

According to third and fourth embodiments, an apparatus may comprise at least one processor and at least one memory comprising computer program code. The at least one memory and the computer program code may be configured to, with the at least one processor, cause the apparatus at least to perform the method of respectively the first and second embodiments, in any of their variations.

According to fifth and sixth embodiments, a computer program product may comprise instructions to perform a process. The process may comprise the method of respectively the first and second embodiments, in any of their variations.

According to seventh and eighth embodiments, a non-transitory computer readable medium may be encoded with instructions that, when executed in hardware, perform a process. The process may comprise the method of respectively the first and second embodiments, in any of their variations.

According to ninth and tenth embodiments, a computer program may comprise code for performing the method of the first and/or the second embodiment above, in any of their variations, when the computer program is run on a processor. The computer program may be a computer program product. A computer program product may, in several embodiments, comprise a computer readable medium encoded with instructions that, when executed in hardware, perform a process. The process may comprise the method of the first and/or the second embodiment above

According to a eleventh embodiment, a system may comprise a first apparatus comprising at least one processor and at least one memory comprising computer program code, wherein the at least one memory and the computer program code are configured to, with the at least one processor, cause the apparatus at least to select a group definition for a set of cell reselection priorities and send the group definition for the set of cell reselection priorities to a network element. The system may also comprise a second apparatus comprising at least one processor and at least one memory comprising computer program code, wherein the at least one memory and the computer program code are configured to, with the at least one processor, cause the apparatus at least to receive a group definition for a set of cell reselection priorities at a network element and initiate autonomous reselection of a cell during an idle mode of the network element by applying the set of cell reselection priorities when the network element falls within the group definition.

According to a twelfth embodiment, an apparatus may comprise selecting means for selecting a group definition for a set of cell reselection priorities. The apparatus may also comprise transmitting means for sending the group definition for the set of cell reselection priorities to a network element. The group definition for the set of cell reselection priorities may be configured to permit the network element to autonomously perform a reselection by applying the set of cell reselection priorities while the network element is in idle mode.

The twelfth embodiment may comprise any of the variations of the first or the second embodiments.

In a variant, the transmitting means may be for sending by broadcasting or multicasting.

In a variant, the apparatus may be a base station, a relay node, or an access point.

In a variant, the selecting means may be for selecting from a predefined set of group definitions.

In a variant, the transmitting means may further be for sending the group definition for the set of cell reselection priorities together with a global absolute reselection priority or a dedicated absolute reselection priority.

In a variant, the sending of the group definition for the set of cell reselection priorities to the network element may comprise sending a plurality of sets of global absolute reselection priorities for different groups of network elements or sending a plurality of sets of dedicated absolute reselection priorities for different groups of network elements.

According to an eleventh embodiment, an apparatus may comprise receiving means for receiving a group definition for a set of cell reselection priorities at a network element. The apparatus may also comprise reselection means for initiating autonomous reselection of a cell during an idle mode of the network element by applying the set of cell reselection priorities when the network element falls within the group definition.

The eleventh embodiment may comprise any of the variations of the first or the second embodiments.

In a variant, the receiving means may further be for receiving the set of cell reselection priorities together with the group definition.

In a variant, the receiving means may further be for receiving at least one condition indicating that the group definition shall be not applied when the condition is met.

In a variant, the receiving means may further be for receiving at least two group definitions.

In a variant, the apparatus may comprise a user equipment or a relay node.

In a variant, the apparatus may further comprise checking means for periodically checking a group status of the network element during the idle mode to initiate the autonomous reselection based on the group status.

### BRIEF DESCRIPTION OF THE DRAWINGS

For proper understanding of the invention, reference should be made to the accompanying drawings, wherein:

FIG. 1 illustrates areas and subareas according to certain embodiments.

FIG. 2 illustrates a method according to certain embodiments.

FIG. 3 illustrates a system according to certain embodiments.

FIG. 4 illustrates another system according to certain embodiments.

### DETAILED DESCRIPTION

A change of properties of the terminal during idle mode may happen if, for example, the terminal changes its velocity, the terminal leaves a certain area, the terminal prepares a service different from the previous services, or the terminal collects a lot of data during idle mode. The change in service may be a change from using real time (RT) services to non-real time (NRT) services. The data collected may be minimization of drive tests (MDT) data or machine type communication (MTC) data.

Within the category of self-organizing networks (SON), one aspect may be SON for user equipment (UE) groups. For example, the network may be enabled to run different optimization for different UE groups. The grouping of the users may be done with respect to the following aspects: UE category/supported release, velocity, service, data storage, operator, location, or other terminal or subscriber properties. Certain embodiments relate to a combination of these aspects, and certain embodiments relate to aspects not comprising velocity.

For example, UE category/supported release may comprise release (Rel)<10 and therefore not capable of enhanced inter-cell interference coordination (eICIC) versus Rel 10>= and therefore eICIC capable. The velocity groups may be fast versus medium versus slow UEs. The service groups may comprise real-time versus non-real-time. Groups may be based on, for example, different amount of data stored during idle mode, for example low, medium, high. The data may be for, for instance, minimization of drive tests logging or data from machine type communication sensors. In equipment sharing scenarios the groups may, for example, be first operator versus second operator. Location groups may be formed to distinguish UEs at different locations. Other terminal or subscriber properties may comprise non-MTC versus MTC, smartphone versus non-smartphone, and MDT versus non-MDT.

Various UEs can be utilized in various embodiments. For example, UEs can include mobile phones, smart phones, electronic book readers, personal digital assistants, email devices, personal computers, tablet computers, laptop computers, terminal devices, sensors, meters, and other devices. In general, certain embodiments may be applicable also to non UE network elements that may select the cell where they may camp on in idle mode, such as, for example, relay nodes.

Certain embodiments provide for the configuration of absolute priorities that control on which cell the users will be camping in idle mode. One goal of the operator may be to make the users camp on “correct” layers, such that they will automatically connect to the best layer when setting up the next call without the necessity of initiating a handover to the best layer while setting up the next call.

The operator of a network may want for UEs belonging to a certain group to set up their calls in a specific layer automatically in order to avoid handovers after they have connected to another layer. Some of the classifications of the terminal, such as category/release, serving operator, may not change during idle mode, others may change during the idle mode of a user. Examples for those group specific preferences may comprise a preference for slow users to use LTE 2.6 GHz, and fast users to use 800 MHz, a preference for voice calls to be setup in 2G/3G and data calls to be set up in LTE, a preference for real-time services to use 800 MHz, due to better service continuity, and for non-real-time/best effort services to use 2.6 GHz.

Additionally, users in areas with many pico cells may prefer the pico layer. In areas with few pico cells, in general with poor availability of a pico layer, preferring the pico layer may lead to a lot of inter-frequency measurements that would drain the battery of the terminal So users in those areas may prefer the macro layer.

Accordingly, certain embodiments provide for autonomous user equipment procedures based on information provided before idle mode, or by making the granularity of broadcasted information finer. Thus, certain embodiments avoid procedures in which the terminal breaks idle mode by waking up.

More particularly, according to certain aspects several sets of absolute reselection priorities may be defined as valid for different properties/groups of the terminals. The corresponding properties/group definitions may be provided by the base station, an access point or a relay node along with the absolute reselection priorities.

Furthermore, the terminal may regularly check its status, such as the terminal's properties and/or which group the terminal currently belongs to. The terminal may choose the corresponding set of absolute reselection priorities based on the status/the group where it belongs.

In one embodiment, two or more sets of global absolute reselection priorities may be broadcasted for different groups of UEs and/or different UE properties. In another embodiment, two or more sets of dedicated absolute reselection priorities may be configured for a certain UE. The reselection properties may be broadcasted, such that all terminals may read all sets, store them, and select the appropriate set depending on their current state, or the reselection properties may be multicasted, such that each terminal may only read the set corresponding to that terminal's own current state.

Different global or dedicated priorities may be configured. For example, different services may have different global or dedicated priorities. In a particular instance, NRT services may be set up in LTE and RT service may be set up in 3G. The terminal may be given the chance to re-select as soon as the service to be setup is determined. This may involve providing a certain “reselection period” during the call setup.

Different global and/or dedicated priorities may be configured e.g. for different locations in the network. For instance, in one part of the network where pico cells are installed, a pico layer may have highest priority, whereas in the other part the macro layer may have highest priority. For example, the selection of preference for macro as opposed to pico may be made in order to avoid inter-frequency measurements.

A proper description of the subareas may be provided in system information block (SIB) or radio resource control (RRC) signaling. The terminals may be able to autonomously identify the subarea.

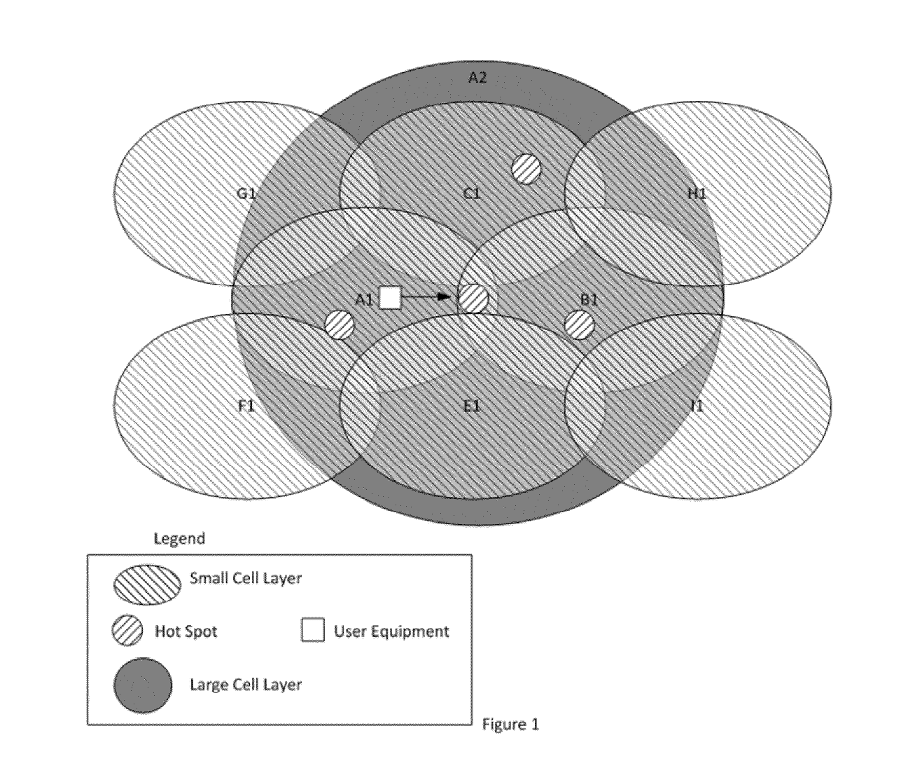

FIG. 1 illustrates areas and subareas according to certain embodiments. As shown in FIG. 1, A1 may be a selected cell on frequency layer f1. B1 and C1 may be neighboring cells on the same frequency layer f1. Moreover, A2, B2, and so on may be cells on frequency layer 12. A1 may broadcast priorities such that f1 has highest priority except if the terminal approaches any or a specific cell edge. This may be useful if the cells on frequency layer 12 are much larger than on layer f1. Terminals on a cell edge in frequency layer f1 may suffer interference, whereas they may have much better signal to interference plus noise ratio (SINR) on frequency layer f2.

Alternatively, the subareas may be defined via signal strength or signal quality conditions, in particular, for dedicated absolute priorities. Signal strength and signal quality conditions may be referred to as radio finger prints. For instance, when releasing the call of a user inside a pico cell, a first set of dedicated priorities may be configured with the pico layer having highest priority. If the signal strength or signal quality falls below a threshold provided together with the priorities, a second set of dedicated priorities may be used with the macro layer having highest priority.

In another alternative, different sets of dedicated absolute reselection priorities may be bound to the cell identity (ID) or the tracking area. For instance, a first set of dedicated prios may be valid for only the current cell ID or current tracking area, whereas a second set may be used for a certain neighboring cell ID or neighboring tracking area, and a third set may be used outside current and neighboring areas.

In a further alternative, different sets of global and dedicated absolute reselection priorities may be bound to global positioning system (GPS or any other kind of positioning system) position if available at the terminal This position information may be available if it is being used by other applications active in the terminal. If the terminal is equipped with a positioning system like for example GPS, but the GPS is not already in use during the idle mode, the terminal may simply switch GPS on prior to connection setup, such that the terminal may reselect according to its positioning. Thus, it is not necessary that the terminal uses GPS during idle mode, if not used by other applications, and so save energy.

The base station, access point or relay node may need to configure areas for which the different sets of absolute priorities are valid. This may be done be polygons with the corners or centers of the polygons being GPS coordinates.

Different global or dedicated absolute priorities may be configured, for example, for slow, medium and fast UEs. For example, slow UEs may be assigned to give priority to 2.6 GHz and fast UEs may be assigned to give priority to 800 MHz. The terminal may choose the appropriate set of absolute reselection priorities based on the terminal's mobility state estimation. The mobility state estimation may be an already existing mobility state estimation.

Different global or dedicated absolute priorities may be configured for smartphones having low, medium or high background traffic or for MTC terminals having small or large amount of data to be transmitted to the network when entering in connected mode. The same may be configured for MDT terminals performing logged MDT in idle mode. Different global or dedicated priorities may be configured for MDT terminals with small or large amounts of logged data.

Different global absolute priorities may be configured, for example, for different terminal categories. For example, Rel 10 terminals may prefer frequency layers with small cells. Likewise, different global absolute priorities may be configured, for example, for different terminal properties such as smartphone and non-smartphones, MTC and non-MTC terminals, MDT and non-MDT terminals, and the like.

Different global absolute priorities may be configured, for example, for terminals belonging to different operators in the case of equipment sharing, such as a virtual network. The first or master operator may want to give absolute priority to a layer that is not even available for a second operator, such as when the second operator has rented capacity in the first operator's network.

Instead of or in addition to providing different sets of dedicated absolute reselection priorities, conditions may be defined under which the terminal shall remove the dedicated priorities (or a part of the dedicated priorities) and may fall back to absolute priorities. For instance, the terminal could be instructed to remove the dedicated priorities (or a part of the dedicated priorities) when the current tracking area is left.

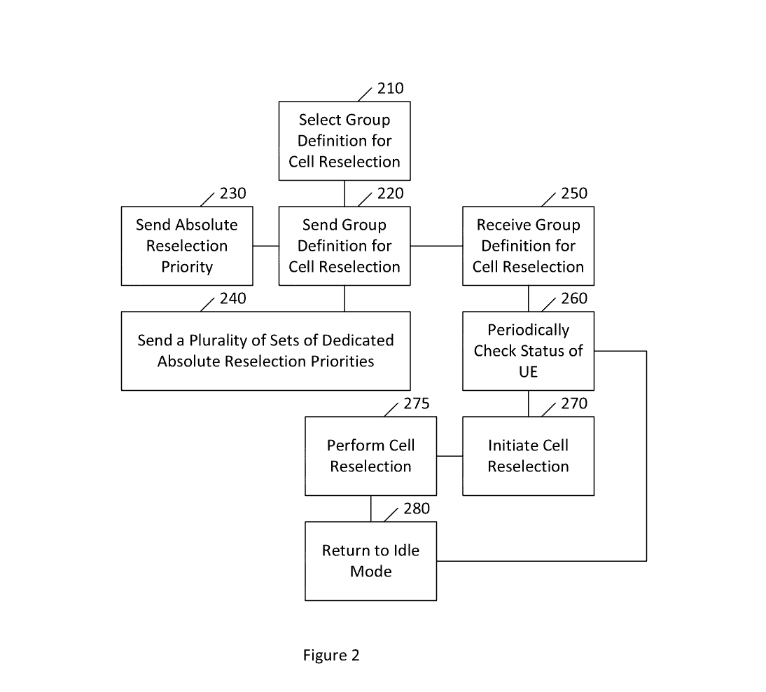

FIG. 2 illustrates a method according to certain embodiments. As shown in FIG. 2, a method may comprise, at 210, selecting a group definition for a set of cell reselection priorities. The selecting may comprise selecting from a predefined set of group definitions. A group definition may define whether a device is within or outside of a particular group. Moreover, the group definition may control which set of priorities the device follows.

The group definition may comprise at least one of the following criteria: a service type supported by the network element; location of the network element; cell size of a selectable cell; signal strength of a selectable cell; received signal quality of a selectable cell; cell identity of a selectable cell; tracking area where a selectable cell belongs to; geographic position of the network element; velocity of the network element; amount of data expected to be send by the network element; network element category; network element type; or network operator of the network element. More generally, the group definition for the set of cell reselection priorities may define priorities corresponding to at least of one different services, different locations, different terminal categories, different terminal properties, different operators, different data amounts, or different mobility states. Moreover, the different locations may comprise subareas defined by at least one of signal strength, signal quality conditions, cell identity, tracking area, or geographic position. The group definitions may comprise any type of network element properties or other criteria which permit the division of network elements into groups.

The set of cell reselection priorities may comprise global absolute reselection priorities or dedicated absolute reselection priorities.

The method may also comprise, at 220, sending the group definition for the set of cell reselection priorities to a network element such as a user equipment, wherein the group definition for the set of cell reselection priorities is configured to permit the user equipment to autonomously reselect while in idle mode. The method may further comprise, at 230, sending the group definition for the set of cell reselection priorities together with an absolute reselection priority. Indeed, the set of cell reselection priorities may be sent together with the group definition. Multicasting or broadcasting may be used for sending the group definition. Two or more group definitions may be selected and sent together. The group definitions may be related to one another or unrelated to one another.

The sending of the group definition for the set of cell reselection priorities to a user equipment may comprise sending a plurality of sets of global absolute reselection priorities for different groups of user equipment and/or different user equipment properties.

The sending of the group definition for the set of cell reselection priorities to a user equipment may comprise, at 240, sending a plurality of sets of dedicated absolute reselection priorities for a user equipment.

The method may also comprise, at 250, receiving the group definition for the set of cell reselection priorities from a network element such as an access point. The method may further comprise, at 270, initiating autonomous reselection of a cell during an idle mode based on the group definition for the set of cell reselection priorities. For example if the one or more group definition leads to the network element belonging to a new group, an autonomous cell reselection may be performed based on the new group and the associated set of cell reselection priorities. Initiating autonomous reselection of a cell during an idle mode may comprise identifying while in idle mode that reselection is to be performed. The initiating may also comprise leaving idle mode in order to perform reselection at 275. After the reselection, the user equipment may return to idle mode, at 280.

In an alternative embodiment, the group definitions, or at least some group definitions are preconfigured in the user equipment. However, in certain embodiments, semi-static/dynamic pre-configuration may be accomplished by signaling from network to terminal. These embodiments may be employed together, with certain group definitions being preconfigured and further group definitions being configured by network signaling.

The method may also comprise, at 260, periodically checking a status of a user equipment during the idle mode to initiate the autonomous reselection based on the status.

The status may comprise at least one of a property of the user equipment or a group to which the user equipment belongs. For example, the status may be the status of a user equipment with respect to being in or out of a particular group. The different locations may comprise subareas defined by at least one of signal strength, signal quality conditions, cell identity, tracking area, or geographic position.

The group definition for the set of cell reselection priorities may define priorities corresponding to at least of one different services, different locations, different terminal categories, different terminal properties, different operators, different data amounts, or different mobility states. Alternatively, or in addition, the group definition for the set of cell reselection priorities may comprise an instruction to remove a dedicated priority and fall back to an absolute priority when a predetermined condition occurs.

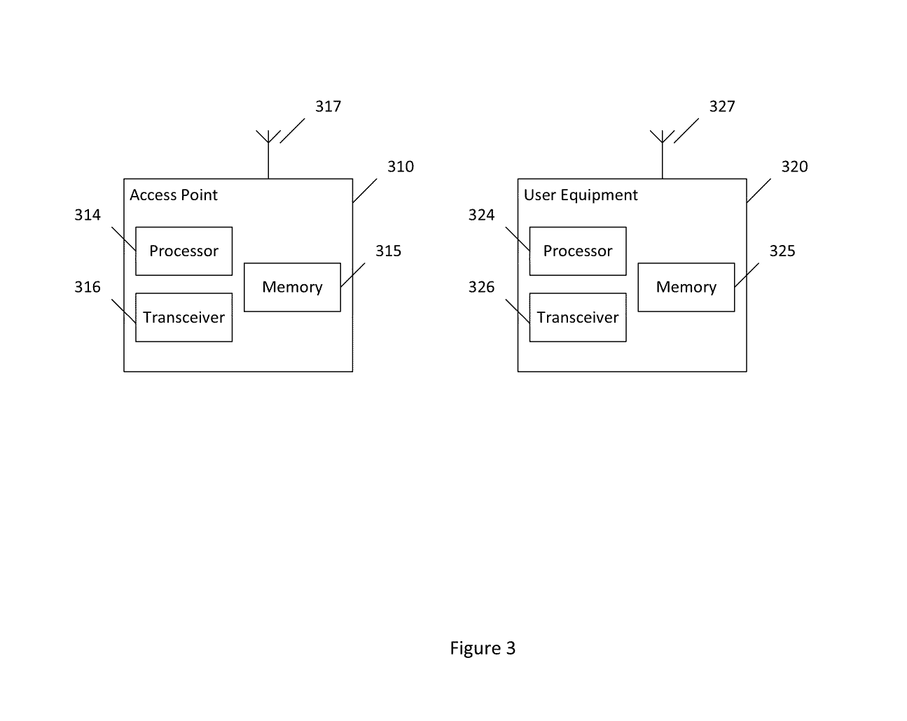

FIG. 3 illustrates a system according to certain embodiments of the invention. In one embodiment, a system may comprise several devices, such as, for example, access point 310 and UE 320. Here access point 310 and UE 320 are simply examples of devices that could be used. As mentioned elsewhere herein, other devices, such as relay nodes may alternatively be used. The system may comprise more than one UE 320 and more than one access point 310, although only one of each is shown for the purposes of illustration. The system may also involve only at least two UEs 320 or only at least two access points 310. Each of these devices may comprise at least one processor, respectively indicated as 314 and 324. At least one memory may be provided in each device, and indicated as 315 and 325, respectively. The memory may comprise computer program instructions or computer code contained therein. One or more transceiver 316 and 326 may be provided, and each device may also comprise an antenna, respectively illustrated as 317 and 327. Although only one antenna each is shown, many antennas and multiple antenna elements may be provided to each of the devices. Other configurations of these devices, for example, may be provided. For example, access point 310 and UE 320 may be additionally configured for wired communication, in addition to wireless communication, and in such a case antennas 317 and 327 may illustrate any form of communication hardware, without being limited to merely an antenna.

Transceivers 316 and 326 may each, independently, be a transmitter, a receiver, or both a transmitter and a receiver, or a unit or device that may be configured both for transmission and reception.

Processors 314 and 324 may be embodied by any computational or data processing device, such as a central processing unit (CPU), application specific integrated circuit (ASIC), or comparable device. The processors may be implemented as a single controller, or a plurality of controllers or processors.

Memories 315 and 325 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language.

The memory and the computer program instructions may be configured, with the processor for the particular device, to cause a hardware apparatus such as access point 310 and UE 320, to perform any of the processes described above (see, for example, FIGS. 1-2). Therefore, in certain embodiments, a non-transitory computer-readable medium may be encoded with computer instructions that, when executed in hardware, may perform a process such as one of the processes described herein. Alternatively, certain embodiments of the invention may be performed entirely in hardware.

Furthermore, although FIG. 3 illustrates a system comprising an access point 310 and a UE 320, embodiments of the invention may be applicable to other configurations, and configurations involving additional elements, as illustrated and discussed herein. For example, multiple user equipment devices and multiple access points may be present, or other nodes providing similar functionality, such as relays which may receive data from an access point and forward the data to a UE and may implement both functionality of the UE and functionality of the access point.

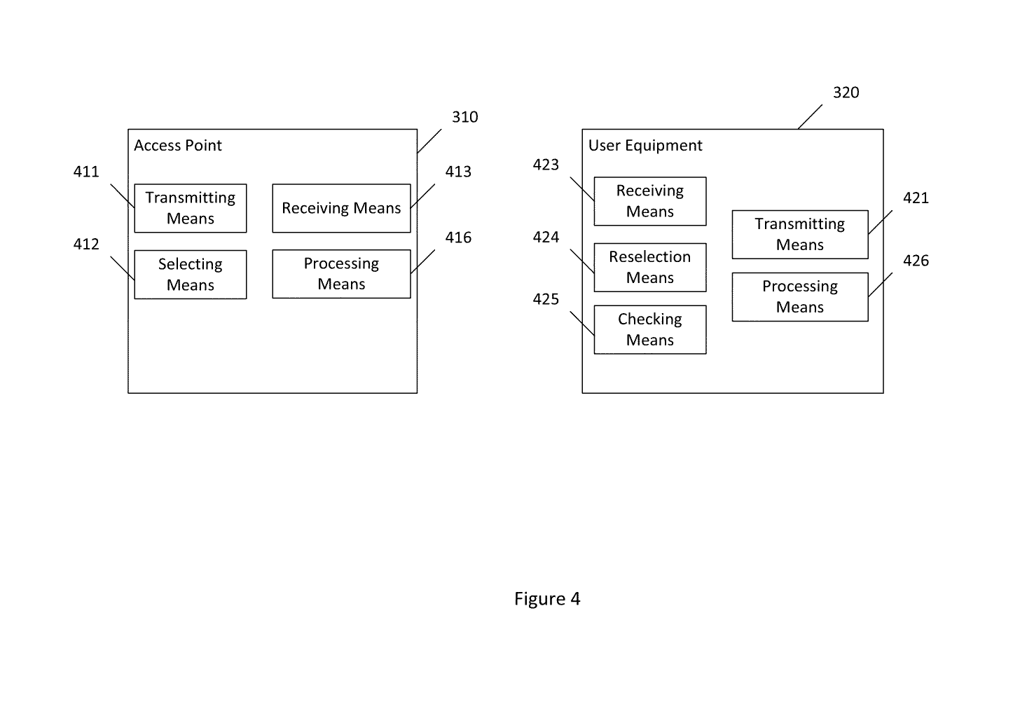

FIG. 4 illustrates another system according to certain embodiments of the invention. The system may comprise an access point 310, and a user equipment 320. Certain embodiments, however, may be used in connection with user equipment to user equipment communication or access point to access point communication, as well as communication amongst other kinds of network elements, such as relay nodes.

The access point 310 may comprise selecting means 412 for selecting a group definition for a set of cell reselection priorities. The access point 310 may also comprise transmitting means 411 for sending the group definition for the set of cell reselection priorities to user equipment 320. The group definition for the set of cell reselection priorities may be configured to permit the user equipment 320 to autonomously reselect while in idle mode.

The selecting and sending may be performed with the various variations described above.

The user equipment 320 may comprise receiving means 423 for receiving a group definition for a set of cell reselection priorities from access point 310. The user equipment 320 may also comprise reselection means 424 for initiating autonomous reselection of a cell during an idle mode based on the group definition for the set of cell reselection priorities.

One or more group definition(s) with associated set(s) of cell reselection priorities may be transmitted by the transmitting means 411 or received by the receiving means 423.

The user equipment 320 may further comprise checking means 425 for periodically checking a status of a user equipment during the idle mode to initiate the autonomous reselection based on the status.

The user equipment 320 may also comprise transmitting means 421 for communicating with the access point 310. Likewise, the access point 310 may also comprise receiving means 413 for receiving communications from the user equipment 320. The user equipment 320 and the access point 310 may comprise processing means, respectively 426 and 416.

One having ordinary skill in the art will readily understand that the invention as discussed above may be practiced with steps in a different order, and/or with hardware elements in configurations which are different than those which are disclosed. For example, while autonomous reselection in idle mode is discussed, it should be understood that certain embodiments may be applied to a device that is not in idle mode. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### GLOSSARY

MDT Minimization of Drive Tests
MTC Machine Type Communication
RT Real-Time
NRT Non-Real-Time
eICIC enhanced Inter-Cell Interference Coordination

We claim:

1. A method, comprising:
selecting a group definition for a set of cell reselection priorities; and
sending the group definition for the set of cell reselection priorities to a network element,
wherein the group definition for the set of cell reselection priorities is configured to permit the network element to autonomously perform a reselection by applying the set of cell reselection priorities while the network element is in idle mode.

2. The method of claim 1, wherein the group definition comprises at least one of the following criteria:
a service type supported by the network element;
location of the network element;
cell size of a selectable cell;
signal strength of a selectable cell;
received signal quality of a selectable cell;
cell identity of a selectable cell;
tracking area where a selectable cell belongs to;
geographic position of the network element;
velocity of the network element;
amount of data expected to be send by the network element;
network element category;
network element type; or
network operator of the network element.

3. The method of claim 1, wherein the set of cell reselection priorities comprises global absolute reselection priorities or dedicated absolute reselection priorities.

4. The method of claim 1, wherein the set of cell reselection priorities is sent together with the group definition and wherein the sending comprises broadcasting or multicasting.

5. The method of claim 1, further comprising:
sending the group definition for the set of cell reselection priorities together with a global absolute reselection priority or a dedicated absolute reselection priority.

6. The method of claim 1, wherein the sending of the group definition for the set of cell reselection priorities to the network element comprises sending a plurality of sets of global absolute reselection priorities for different groups of network elements or sending a plurality of sets of dedicated absolute reselection priorities for different groups of network elements.

7. A method, comprising:
receiving a group definition for a set of cell reselection priorities at a network element; and
initiating autonomous reselection of a cell during an idle mode of the network element by applying the set of cell reselection priorities when the network element falls within the group definition.

8. The method of claim 7, wherein the group definition comprises at least one of the following criteria:
a service type supported by the network element;
location of the network element;
cell size of a selectable cell;
signal strength of a selectable cell;
received signal quality of a selectable cell;
cell identity of a selectable cell;
tracking area where a selectable cell belongs to;
geographic position of the network element;
velocity of the network element;
amount of data expected to be send by the network element;
network element category;
network element type; or
network operator of the network element.

9. The method of claim 7, wherein the set of cell reselection priorities comprises global absolute reselection priorities or dedicated absolute reselection priorities.

10. The method of claim 7, wherein the set of cell reselection priorities is received together with the group definition.

11. The method of claim 7, wherein at least two group definitions are received.

12. The method of claim 7, further comprising:
periodically checking a group status of the network element during the idle mode to initiate the autonomous reselection based on the group status.

13. An apparatus, comprising:
at least one processor; and
at least one memory comprising computer program code,
wherein the at least one memory and the computer program code are configured to, with the at least one processor, cause the apparatus at least to
select a group definition for a set of cell reselection priorities; and
send the group definition for the set of cell reselection priorities to a network element,
wherein the group definition for the set of cell reselection priorities is configured to permit the network element to autonomously perform a reselection by applying the set of cell reselection priorities while the network element is in idle mode.

14. The apparatus of claim 13, wherein the group definition comprises at least one of the following criteria:
a service type supported by the network element;
location of the network element;
cell size of a selectable cell;
signal strength of a selectable cell;
received signal quality of a selectable cell;
cell identity of a selectable cell;
tracking area where a selectable cell belongs to;
geographic position of the network element;
velocity of the network element;
amount of data expected to be send by the network element;
network element category;
network element type; or
network operator of the network element.

15. The apparatus of claim 13, wherein the set of cell reselection priorities comprises global absolute reselection priorities or dedicated absolute reselection priorities.

16. The apparatus of claim 13, wherein the set of cell reselection priorities is sent together with the group definition and wherein the sending comprises broadcasting or multicasting.

17. The apparatus of claim 13, wherein the apparatus comprises a base station, relay node, or an access point.

18. The apparatus of claim 13, wherein the at least one memory and the computer program code are configured to, with the at least one processor, cause the apparatus at least to send the group definition for the set of cell reselection priorities together with a global absolute reselection priority or a dedicated absolute reselection priority.

19. The apparatus of claim 13, wherein the at least one memory and the computer program code are configured to, with the at least one processor, cause the apparatus at least to send the group definition for the set of cell reselection priorities to the network element by sending a plurality of sets of global absolute reselection priorities for different groups of network elements or sending a plurality of sets of dedicated absolute reselection priorities for different groups of network elements.

20. An apparatus, comprising:
at least one processor; and
at least one memory comprising computer program code,
wherein the at least one memory and the computer program code are configured to, with the at least one processor, cause the apparatus at least to
receive a group definition for a set of cell reselection priorities at a network element; and
initiate autonomous reselection of a cell during an idle mode of the network element by applying the set of cell reselection priorities when the network element falls within the group definition.

21. The apparatus of claim 20, wherein the group definition comprises at least one of the following criteria:
a service type supported by the network element;
location of the network element;
cell size of a selectable cell;
signal strength of a selectable cell;
received signal quality of a selectable cell;
cell identity of a selectable cell;
tracking area where a selectable cell belongs to;
geographic position of the network element;
velocity of the network element;
amount of data expected to be send by the network element;
network element category;
network element type; or
network operator of the network element.

22. The apparatus of claim 20, wherein the set of cell reselection priorities comprises global absolute reselection priorities or dedicated absolute reselection priorities.

23. The apparatus of claim 20, wherein the set of cell reselection priorities is received together with the group definition.

24. The apparatus of claim 20, wherein the at least one memory and the computer program code are configured to, with the at least one processor, cause the apparatus at least to receive at least two group definitions.

25. The apparatus of claim 20, wherein the network element is a user equipment or a relay node.

26. The apparatus of claim 20, wherein the at least one memory and the computer program code are configured to, with the at least one processor, cause the apparatus at least to periodically check a group status of the network element during the idle mode to initiate the autonomous reselection based on the group status.

27. A non-transitory computer readable medium encoded with instructions that, when executed in hardware, perform a process, the process comprising:
selecting a group definition for a set of cell reselection priorities; and
sending the group definition for the set of cell reselection priorities to a network element,
wherein the group definition for the set of cell reselection priorities is configured to permit the network element to autonomously perform a reselection by applying the set of cell reselection priorities while the network element is in idle mode.

28. A non-transitory computer readable medium encoded with instructions that, when executed in hardware, perform a process, the process comprising:
receiving a group definition for a set of cell reselection priorities at a network element; and
initiating autonomous reselection of a cell during an idle mode of the network element by applying the set of cell reselection priorities when the network element falls within the group definition.
